(19) United States
(12) Patent Application Publication
(10) Pub. No.: US 2015/0028147 A1
(43) Pub. Date: Jan. 29, 2015

(54) Cable Support Stand

(71) Applicant: Roy Rich, Morristown, TN (US)

(72) Inventor: Roy Rich, Morristown, TN (US)

(21) Appl. No.: 14/444,500

(22) Filed: Jul. 28, 2014

Related U.S. Application Data
(60) Provisional application No. 61/858,696, filed on Jul. 26, 2013.

(51) Int. Cl. B65H 75/44; F16M 11/14

(52) U.S. Cl. CPC B65H 75/4457; F16M 11/14
USPC 242/399.2; 242/398

(57) ABSTRACT

A cable support system includes a frame having a first side, a second side, a top and a bottom; an axle disposed through the frame extending from the first side to the second side; a drum having a rim for receiving the axle such that the drum is supported by and rotates on the axle, wherein the drum is in rollable contact with the cable for supporting the cable and configured for cable to move across surface of the drum while the drum is rotating to facilitate paying out or taking up the cable as the drum rotates; and a stand having a top portion in contact with the bottom of the frame and a plurality of legs which extend downwardly from the top portion, wherein the legs and top portion elevate the frame to facilitate the pay out or taking up of the cable over objects below the frame.

### CROSS-REFERENCE TO RELATED APPLICATIONS

This Application is claims the benefit of U.S. Provisional Patent Application Ser. No. 61/858,696, filed Jul. 26, 2013, the contents of which are incorporated herein by reference in their entirety.

STATEMENT REGARDING FEDERALLY SPONSORED RESEARCH OR DEVELOPMENT

Not Applicable.

### BACKGROUND OF THE INVENTION

1. Field of Invention

The present application relates generally to cable installation systems, and more particularly to a cable elevation support system.

2. Description of the Related Art

Large diameter electrical cable, wire rope and flexible tubing such as that used to distribute natural gas are usually supplied on large wooden spools or reels. Reels of this type have a cylindrical barrel for winding cable or the like, and a pair of disk-shaped flanges of larger diameter than the barrel at opposite ends of the barrel, for retaining material wound onto the barrel. The combined weight of a reel and the cable, tubing or the like wound onto the reel may exceed several hundred pounds. Accordingly, moving such reels between various locations at a job site can often be a cumbersome and laborious task. Moreover, paying cable or tubing off of a reel, or winding such material back onto a reel, are laborious tasks. One type of prior art device used for handling heavy cable reels includes a pair of laterally opposed parallel rails to receive the circular end plate flanges of the reel. Rollers mounted within the channels rotatably support the rims of the cable reel flanges, allowing the cable to rotate to permit paying out or taking up cable. Such devices provide no means for transporting cable reels.

A variety of other types of devices intended to facilitate the handling of reels or cylindrical objects are disclosed in the following U.S. patents:

Pelletier, U.S. Pat. No. 4,030,679 discloses an identical pair of support stands for lifting a roll of floor covering material from a position on a supporting surface to an elevated position in which the roll is free to rotate, allowing materials to be unrolled. The axle of a carpet roll is supported by upwardly opening yokes, attached to each support stand, which has a short horizontally disposed base leg and a longer vertical standard.

Gebo, U.S. Pat. No. 4,469,289 discloses a reel stand apparatus for rollably supporting a reel or spool of cable, the apparatus consisting of a pair of stanchions each having a base frame including a pair of short perpendicularly disposed horizontal frame members and a vertical post having a rollable reel axle support.

Setzke, U.S. Pat. No. 4,746,078 discloses a reel lifting and support device having a pair of identical units each comprising a lower elongated support arm which is initially disposed in a generally horizontal position, a short arm disposed obliquely upwardly from a distal end of the long arm, and a plurality of sockets disposed perpendicularly to the upper portion of the short arm, for receiving support axles for reels of different heights. Each unit also includes a brace unit or beam member pivotably connected to the short arm between the sockets, the brace unit being disposed obliquely downwards towards the long arm and being pivotably attached thereto. A short hollow cylindrical tube disposed transversely across the junction of the long arm and short arm serves as a fulcrum and pivot axis for the apparatus so that when the long arms are pivoted down from an upwardly angled position to a horizontal position, a reel on an axle supported by the sockets is pivoted upwards to a freely rotatable position above the ground, because short arm and the attached sockets are thereby pivoted to a higher altitude.

Arrington, U.S. Pat. No. 4,932,601 discloses a reel lift comprising a pair of identical stands, each having a short horizontally disposed angle iron base, a short angle iron upright member depending perpendicularly upwards from the base, a handle rod fastened to and extending parallel upwards from the upright member, and a reel axle support sleeve fastened transversely to one side of the upright member, near its upper end. The front edge of each angle iron base plate serves as a fulcrum or pivot edge when the apparatus with attached cable reel is pivoted from a position in which the handle are angled downwards from an upright vertical position, to a vertical position in which the cable reeling elevated above a support surface to permit its free rotation.

There are other support devices designed for spools or reels. Typical of these is U.S. Pat. No. 442,309 issued to Diamond et al. on Dec. 9, 1890. Another patent was issued to Topp on Jan. 1, 1924 as U.S. Pat. No. 1,479,209. Yet another U.S. Pat. No. 1,509,717 was issued to Davis on Sep. 23, 1924 and still yet another was issued on May 14, 1968 to Godson as U.S. Pat. No. 3,383,071. Another patent was issued to Peterson on Jan. 29, 1985 as U.S. Pat. No. 4,496,028. Yet another U.S. Pat. No. 4,752,047 was issued to Franks, Jr. on Jun. 21, 1988. Another was issued to Arrington on Jun. 12, 1990 as U.S. Pat. No. 4,932,601 and still yet another was issued on Dec. 2, 1997 to Holliday as U.S. Pat. No. 5,692,701. Another patent was issued to Honnecke, et al. on Jun. 20, 2000 as U.S. Pat. No. 6,076,780. Yet another U.S. Pat. No. 6,299,100 was issued to Cloud on Oct. 9, 2001. Another was issued to Standard Telefon Og Kabel-Fabric on Feb. 10, 1960 as United Kingdom No. GB827,826 and still yet another was issued on Aug. 12, 1964 to Clarke as United Kingdom Patent No. GB966,726.

Efforts regarding such systems have led to continuing developments to improve their functionality, versatility, practicality and efficiency.

### BRIEF SUMMARY OF THE INVENTION

The object of the present invention is to avoid disadvantages of the prior art.

A cable support system includes a frame having a first side, a second side, a top and a bottom; an axle disposed through the frame extending from the first side to the second side; a drum having a rim for receiving the axle such that the drum is supported by and rotates on the axle, wherein the drum is in rollable contact with the cable for supporting the cable and configured for cable to move across surface of the drum while the drum is rotating to facilitate paying out or taking up the cable as the drum rotates; and a stand having a top portion in contact with the bottom of the frame and a plurality of legs which extend downwardly from the top portion, wherein the legs and top portion elevate the frame to facilitate the pay out or taking up of the cable over objects below the frame.

In some embodiments, an apparatus in accordance with the present general inventive concept further includes a rotation system configured to facilitate the frame to rotate about an axis approximately perpendicular to the axis of rotation of the drum.

In some embodiments, the rotation system encompasses a pin and hole system.

Some embodiments further include a tilt system configured to facilitate tilting of the frame to change the axis of rotation of the drum.

In some embodiments, the tilt system comprises a ball and socket system.

Some embodiments further include a rotation system configured to facilitate the frame to rotate about three axes.

In some embodiments, the rotation system comprises a ball and socket system.

In some example embodiments of the present general inventive concept, a cable support system includes a frame having a first side, a second side, a top and a bottom; an axle disposed through the frame extending from the first side to the second side; a drum having a rim for receiving the axle such that the drum is supported by and rotates on the axle, said drum being in rollable contact with the cable to support the cable, said drum being configured for cable to move across surface of the drum while the drum is rotating to facilitate paying out or taking up the cable as the drum rotates; and a stand having a top portion in contact with the bottom of the frame and a plurality of legs which extend downwardly from the top portion, wherein the legs and top portion elevate the frame to facilitate the pay out or taking up of the cable over objects below the frame.

In some embodiments, the cable support further encompasses a rotation system configured to facilitate the frame to rotate about an axis approximately perpendicular to the axis of rotation of the drum.

In some embodiments, the rotation system comprises a pin and hole system.

Some embodiments further include a tilt system configured to facilitate tilting of the frame to change the axis of rotation of the drum.

In some embodiments, the tilt system comprises a ball and socket system.

Some embodiments further include a rotation system configured to facilitate the frame to rotate about three axes.

In some embodiments, the rotation system comprises a ball and socket system.

In some embodiments, the drum has a first part that tapers to be flush with the first side and a first part that tapers to be flush with the second side.

### BRIEF DESCRIPTION OF THE SEVERAL VIEWS OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a plan view of an embodiment of a cable support system;

FIG. 2 is a front view of an embodiment of a cable support system; and

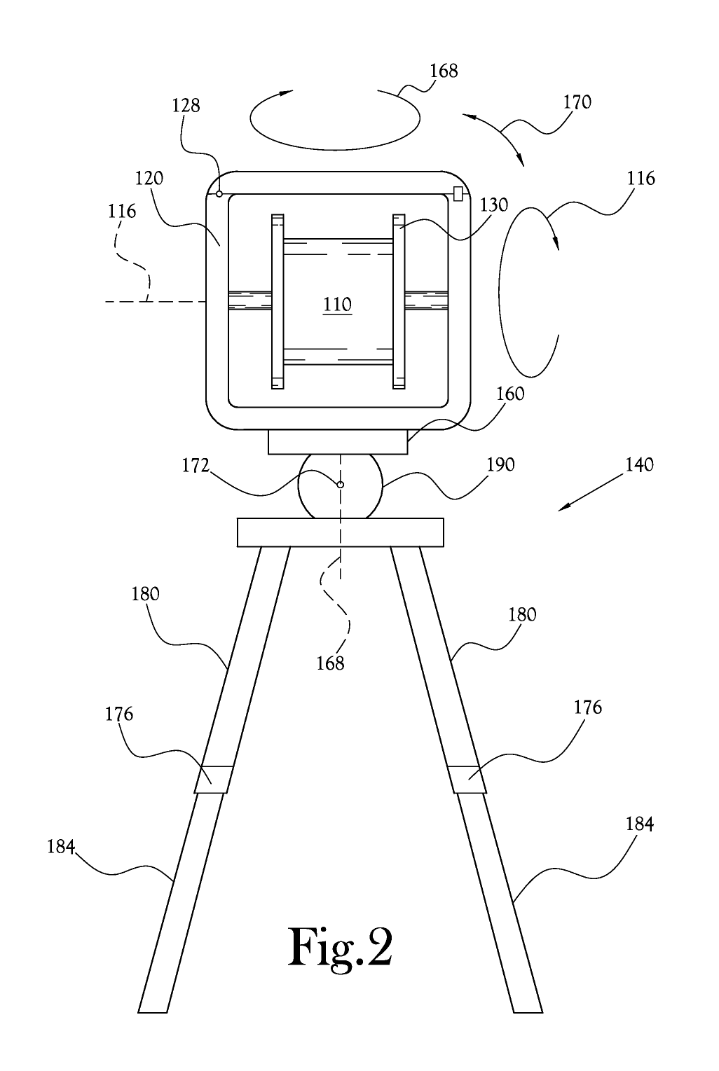

FIGS. 3A-3D are magnified views of embodiments of support legs for a cable system.

### DETAILED DESCRIPTION OF THE INVENTION

In some example embodiments of the present general inventive concept, as disclosed herein, a cable support system includes a frame having a first side, a second side, a top and a bottom; an axle disposed through the frame extending from the first side to the second side; a drum having a rim for receiving the axle such that the drum is supported by and rotates on the axle, wherein the drum is in rollable contact with the cable for supporting the cable and configured for cable to move across surface of the drum while the drum is rotating to facilitate paying out or taking up the cable as the drum rotates; and a stand having a top portion in contact with the bottom of the frame and a plurality of legs which extend downwardly from the top portion, wherein the legs and top portion elevate the frame to facilitate the pay out or taking up of the cable over objects below the frame.

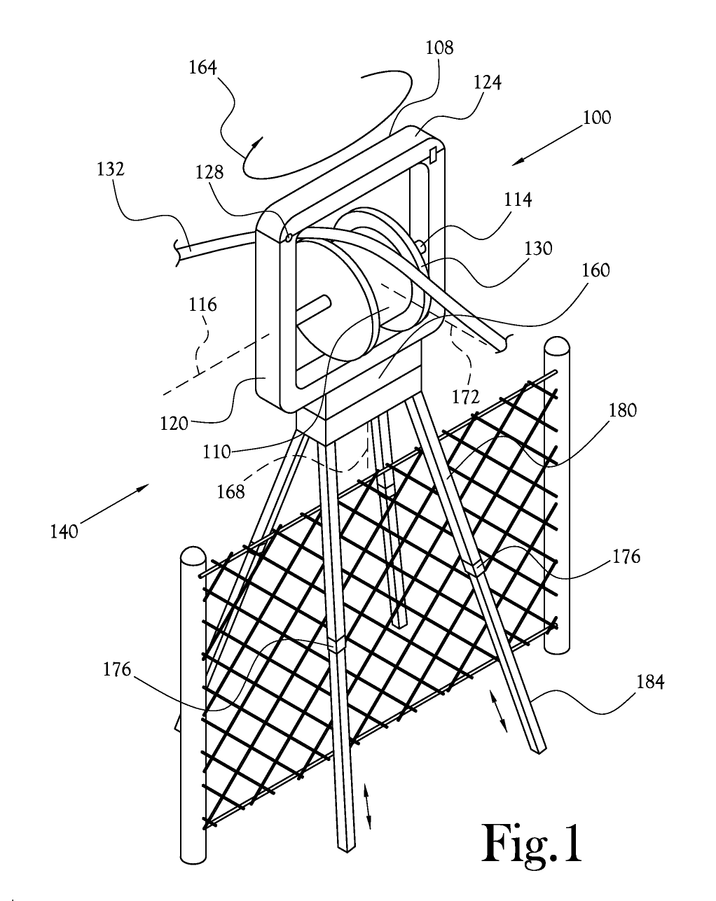

Referring now to the Figures, FIG. 1 shows a plan view of one example embodiment cable support system 100 according to the present general inventive concept. The example cable support system 100 includes a roller box 108 which includes a roller 110 or drum which has a substantially circular side view. The roller rotates or spins about an axle, axis or spindle 114 which may be a rod or tube type structure which extends through the center of the roller along an axis of rotation 116. The roller may be disposed in a containment box or frame 120. The roller and spindle are supported by the frame. The frame may have a pivoting top 124 which may pivot about a joint, point or hinge 128. The hinge permits the top of the frame to open easily to permit cable or other flexible tubing, hosing or wire to be placed on top of and to rotate around the roller. A cable 132 is in rollable or rotational contact with the drum and can be pulled through the frame via rotation of the drum. As cable is pulled through the frame, the cable weight and friction of the cable causes the drum to rotate, thereby easing the force necessary to pull the cable.

An example cable support comprises a stand 140 having a plurality (e.g. 4) of legs attached to a swivel plate 160. The frame is connected to and supported by the swivel plate. The swivel plate may be configured to facilitate the frame to rotate or swivel (arrows 164) about an axis of rotation 168.

In an example, the swivel plate is configured to facilitate tilting (arrows 170) or rotation of the frame from side to side about an axis of rotation 172.

In an example, the frame and swivel plate are connected or joined utilizing a ball 190 and socket type arrangement. A ball and socket type arrangement may facilitate the frame to rotate about three axes.

In an example, the frame and swivel plate are connected or joined in a configuration that the support system for the drum and drum combination operate similar to the operation of a gyroscope with the drum at the center.

In an example, at least one leg may have a joint 176 that is configured to facilitate telescoping between an upper leg section 180 and a lower leg section 184. The lower leg section may slide into the upper leg section or vice-versa and the joint may have a locked and unlocked state to prevent or permit telescoping. In an example, the joint may be collar which twists to tighten and loosen the gripping force between leg sections.

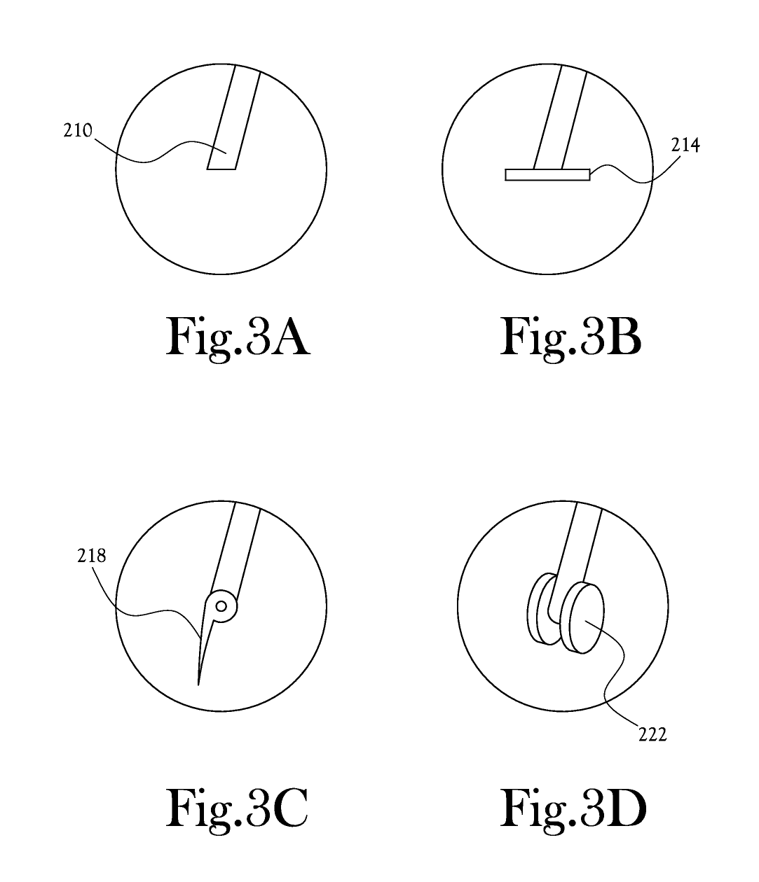

Referring to FIGS. 3A-3D illustrate examples of leg ends wherein at least one leg 210 that may have a foot 214, spike 218, locking wheel 222 or other device on which the leg rests on the ground with. The leg may be stationary or planted or rollable with a wheel. In another example, at least one leg may have a device which permits the leg to move, roll or slide. In another example, at least one leg may have a device which permits the leg to move along the ground in an unlocked state and to remain stationary in a locked state.

In an example, the cable support facilitates lifting and supporting a cable above a supporting surface to allow cable to be payed out from or onto an externally located reel, and for facilitating movement of a cable to various desired locations at a job site. In an example, the cable support facilitates cable to be payed out across obstacles, such as a fence, stream, wall, etc.

In an example, the cable support apparatus enables a single individual to elevate a heavy cable to a freely rotatable position, with the apparatus disposed in a first orientation, and which enables a single individual to transport the cable to a position in a second orientation. Another example use is a cable reel transporter which may be readily knocked down, stored and transported by a single individual. Another object of the invention is to provide a cable reel lifter/transporter which may accommodate cable reels having a wide range of widths as well as diameters.

An example of the cable support system comprises a frame having a first side, a second side, a top and a bottom; an axle disposed through the frame extending from the first side to the second side; a drum having a rim for receiving the axle such that the drum is supported by and rotates on the axle, wherein the drum is in rollable contact with the cable for supporting the cable and configured for cable to move across surface of the drum while the drum is rotating to facilitate paying out or taking up the cable as the drum rotates; and a stand having a top portion in contact with the bottom of the frame and a plurality of legs which extend downwardly from the top portion, wherein the legs and top portion elevate the frame to facilitate the pay out or taking up of the cable over objects below the frame.

As described above, in some example embodiments of the present general inventive concept, the drum is supported by the axle, which is disposed through the frame and extends from the first side of the frame to the second side of the frame. The drum and axle are therefore both located within the frame. In some embodiments, the shape of the drum is such that the space between the drum and the first side of the frame and between the drum and the second side of the frame is negligible or, at any rate, much smaller than the diameter of the cable that is in contact with the drum. In some embodiments, the drum tapers in such a way as to be effectively flush with the first side of the frame and with the second side of the frame. This arrangement helps to minimize the possibility of snags or the possibility of the cable becoming caught in a space between the drum and the frame. In some embodiments, the drum has a first part that tapers to be flush with the first side and a first part that tapers to be flush with the second side. In some embodiments, the drum, axle and frame are structurally similar to, for example, the XS-100B Universal Stringing Blocks manufactured by Sherman+Reilly, Inc., of Chattanooga, Tenn. Those of skill in the art will recognize other variations that fall within the scope of the present general inventive concept.

Some example embodiments further comprise a rotation system configured to facilitate the frame to rotate about an axis approximately perpendicular to the axis of rotation of the drum. An example further comprises a rotation system comprised of a pin and hole system. An example further comprises a tilt system configured to facilitate tilting of the frame to change the axis of rotation of the drum. An example further comprises a tilt system comprising a ball and socket system. An example further comprises a rotation system configured to facilitate the frame to rotate about three axes. An example further comprises a rotation system comprising a ball and socket system.

While the present general inventive concept has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The present general inventive concept in its broader aspects is therefore not limited to the specific details, representative apparatus and methods, and illustrative examples shown and described. Accordingly, departures may be made from such details without departing from the spirit or scope of applicant's general inventive concept.

Still other embodiments will become readily apparent to those skilled in this art from reading the above-recited detailed description in view of all the drawings. It is noted that the simplified diagrams do not illustrate all the various connections and assemblies of the various components, however, those skilled in the art will understand how to implement such connections and assemblies, based on the illustrated components, figures, and descriptions provided herein.

It is also noted that numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Accordingly, while the present general inventive concept has been illustrated by description of several embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

While embodiments are described herein, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for manipulating cable comprising:
a frame having a first side, a second side, a top and a bottom;
an axle disposed through the frame extending from the first side to the second side;
a drum having a rim for receiving the axle such that the drum is supported by and rotates on the axle, wherein the drum is in rollable contact with the cable for supporting the cable and configured for cable to move across surface of the drum while the drum is rotating to facilitate paying out or taking up the cable as the drum rotates; and
a stand having a top portion in contact with the bottom of the frame and a plurality of legs which extend downwardly from the top portion, wherein the legs and top portion elevate the frame to facilitate the pay out or taking up of the cable over objects below the frame.

2. An apparatus in accordance with claim 1, further comprising a rotation system configured to facilitate the frame to rotate about an axis approximately perpendicular to the axis of rotation of the drum.

3. An apparatus in accordance with claim 2, wherein the rotation system comprises a pin and hole system.

4. An apparatus in accordance with claim 1, further comprising a tilt system configured to facilitate tilting of the frame to change the axis of rotation of the drum.

5. An apparatus in accordance with claim 4, wherein the tilt system comprises a ball and socket system.

6. An apparatus in accordance with claim 1, further comprising a rotation system configured to facilitate the frame to rotate about three axes.

7. An apparatus in accordance with claim 6, wherein the rotation system comprises a ball and socket system.

8. A cable support system comprising:
a frame having a first side, a second side, a top and a bottom;
an axle disposed through the frame extending from the first side to the second side;
a drum having a rim for receiving the axle such that the drum is supported by and rotates on the axle, said drum being in rollable contact with the cable to support the cable, said drum being configured for cable to move across surface of the drum while the drum is rotating to facilitate paying out or taking up the cable as the drum rotates; and
a stand having a top portion in contact with the bottom of the frame and a plurality of legs which extend downwardly from the top portion, wherein the legs and top portion elevate the frame to facilitate the pay out or taking up of the cable over objects below the frame.

9. The cable support system according to claim 8, further comprising a rotation system configured to facilitate the frame to rotate about an axis approximately perpendicular to the axis of rotation of the drum.

10. The cable support system according to claim 9, wherein the rotation system comprises a pin and hole system.

11. The cable support system according to claim 8, further comprising a tilt system configured to facilitate tilting of the frame to change the axis of rotation of the drum.

12. The cable support system according to claim 11, wherein the tilt system comprises a ball and socket system.

13. The cable support system according to claim 8, further comprising a rotation system configured to facilitate the frame to rotate about three axes.

14. The cable support system according to claim 13, wherein the rotation system comprises a ball and socket system.

15. The cable support system according to claim 8, wherein said drum has a first part that tapers to be flush with the first side and a first part that tapers to be flush with the second side.
